(19) United States
(12) Patent Application Publication
(10) Pub. No.: US 2003/0110265 A1
(43) Pub. Date: Jun. 12, 2003

(54) Method and apparatus for providing a virtual shared device

(75) Inventors: Mark J. Lutian, Clinton, CT (US); Graham Yarbrough, Sandy Hook, CT (US)

Correspondence Address: BAKER & HOSTETLER LLP, Suite 1100, Washington Square, 1050 Connecticut Avenue, N.W., Washington, DC, 20036, US

(73) Assignee: Inrange Technologies Inc.

(21) Appl. No.: 10/004,878

(22) Filed: Dec. 7, 2001

(51) Int. Cl. G06F 15/16

(52) U.S. Cl. 709/227; 711/111; 703/21; 709/246

(57) ABSTRACT

An apparatus and method for providing simultaneous access to data on a mainframe computer. The apparatus includes an emulation, which contains the data, appears to a mainframe computing system as a peripheral device. The peripheral provides access to the data to a plurality of requesters simultaneously through the creation of unique nominal IDs for each request.

### FIELD OF THE INVENTION

The present invention relates generally to access to data in a mainframe environment. More particularly, the present invention relates to granting multiple requests for access to data in an environment that otherwise allows only one user to access it at a time.

### BACKGROUND OF THE INVENTION

Computing networks, such as the Internet, have become so widely used, in part, because of the ability of various computers connected to the networks to share data. These networks and computers are often referred to as open systems and are capable of sharing data due to commonality among the data handling protocols supported by the networks and computers. For example, a server at one end of the Internet can provide airline flight data to a personal computer in a consumer's home. The consumer can then make flight arrangements, including paying for the flight reservation, without having to speak with an airline agent or having to travel to a ticket office. This is but one scenario in which open systems are used.

One type of computer system that has not kept up with the times is the mainframe computer. A mainframe computer was at one time considered a very sophisticated computer, capable of handling many more processes and transactions than the personal computer. Because the mainframe is not an open system, its utility is somewhat reduced because legacy data that are stored on tapes and read by mainframes via tape drives are unable to be used by open systems. In the airline scenario discussed above, the airline is unable to make the mainframe data available to consumers.

FIG. 1 illustrates a present day environment of the mainframe computer. The airline, Airline A, has two mainframes, a first mainframe 10 (Mainframe A) and a second mainframe 12 (Mainframe B). The mainframes may be in the same room or may be separated by a building, city, state or continent.

The mainframes 10 and 12 have respective tape drives 14 and 16 to access and store data on data tape 18 and 20 corresponding to the tasks with which the mainframes are charged. Respective local tape storage bins 22 and 24 store the data tapes 14, 16.

During the course of a day, a technician 26 servicing Mainframe A 10 loads and unloads the data tapes 18. Though shown as a single tape storage 22, the tape storage bin 22 may actually be the entire warehouse filled with data tapes 18. Thus, each time a new tape is requested by a user of Mainframe, the technician 26 retrieves a data tape 18 and inserts it into the tape drive 14 of the Mainframe A 10.

Similarly, a technician 28 services Mainframe B 12 with its respective data tapes 22. In the event an operator 26 of Mainframe A 10 desires data from a Mainframe B data tape 20, the second technician 28 must retrieve the tape and send it to the first technician 26, who inserts it into the Mainframe A tape drive 14. If a large distance separates the mainframes, then the data tape 20 must be shipped across this distance. As a result, the tape becomes unavailable to Mainframe B 12.

FIG. 2 is an illustration of a prior art channel-to channel adapter 30 used to solve the problem of data sharing between Mainframe A 10 and B 12 that reside in the same location. The channel-to-channel adapter 30 is in communication with both Mainframes A 10 and B 12. In this scenario, it is assumed that Mainframe A 10 uses an operating system having a first protocol, protocol A, and Mainframe B 12 uses an operating system having a second protocol, protocol B. It is further assumed that the channel-to-channel adapter 30 uses a third operating system having a third protocol, protocol C.

The adapter 30 negotiates communications between Mainframes A 10 and B 12. Once the negotiation is completed, the Mainframes A 10 and B 12 are able to transmit and receive data with one another according to the rules negotiated.

In this scenario, all legacy applications operating on Mainframes A 10 and B 12 have to be rewritten to communicate with the protocol of the channel-to-channel adapter 30. A hindrance to this resolution is that legacy applications may be written in relatively archaic programming languages, such as COBOL. Because many of the legacy applications are written in older programming languages, the legacy applications are difficult to maintain, let alone upgrade, to use the channel-to-channel adapter 30 to share between the mainframes.

Another type of adapter used to share data among mainframes or other computers in heterogeneous computing environments is described in U.S. Pat. No. 6,141,701, issued Oct. 31, 2000, entitled “System for, and Method of, Off-Loading Network Transactions from a Mainframe to and Intelligent Input/Output Device, Including Message Queuing Facilities,” to Whitney. The adapter described by Whitney is a message oriented middleware system that facilities the exchange of information between computing system with different processing characteristics, such as different operating systems, processing architectures, data storage formats, file subsystems, communication stacks, and the like. Of particular relevance is the family of products known as “message queuing facilities” (MQF). Message queuing facilities help applications in one computing system communicate with applications in another computing system by using queues to insulate or abstract each other's differences. The sending applications connect to a queue manager (a component of the MQF) and opens the local queue using the queue manager's queue definition (both the connect and open are executable verbs in a message queue series (MQSeries) applications programming interface [API]).

Before sending a message, an MQF typically commits the message to persistent storage, typically to a direct access storage device (DASD). Once the message is committed to persistent storage, the MQF sends the message via the communications stack to the recipient's complementary and remote MQF.

The remote MQF commits the message to persistent storage and sends an acknowledgment to the sending MQF. The acknowledgment back to the sending queue manager permits it to delete the message from the sender's persistent storage. The message stays on the remote MQF's persistent storage until the receiving application indicates it has completed its processing of it. The queue definition indicates whether the remote MQF must trigger the receiving application or if the receiver will poll the queue on its own. The use of a persistent storage facilities recoverability. This is know as persistent queue.

Eventually, the receiving applications is informed of the message on the local queue (i.e. the remote queue with respect to the sending application), and it, like the sending application, connects to its local queue manager and opens the queue on which the message resides. The receiving application can then execute get or browse verbs to either read the message from the queue or just look at it.

When either application is done processing its queue, it is free to issue the close verb and disconnect from the queue.

The persistent queue storage used by the MQF is logically an indexed sequential data set file. The messages are typically placed in the queue on a first-in, first-out (FIFO) basis, but the queue model also allows indexed access for browsing and he direct access of the messages in the queue.

Though MQF is helpful for many applications, current MQF and related software utilize considerable mainframe resources. Moreover, modern MQF's have limited, if any, finctionality allowing shared queues to be supported.

The problems with the solutions offered by Whitney is similar to that of the adapter 30 (FIG. 2) in that the legacy applications of the mainframe must be written to use the protocol of the MQF. This causes a company, such as an airline, that is not in the business of maintaining and upgrading legacy software, to expend resources upgrading the mainframes to work with the MQF to communicate with today's open computer systems and to share data even among their own mainframes. This does not address the problems encountered when mainframes are located in different cities.

Another type of adapter used to share data among mainframes or other computers in heterogeneous computing environments is described in U.S. Pat. No. 5,906,658, issued May 25, 1999, entitled “Message Queuing on a Data Storage System Utilizing Message Queuing in Intended Recipient's Queue,” by Raz. Raz provides, in one aspect, a method for transferring messages between a plurality of processes that are communicating with a data storage system, wherein the plurality of processes access the data storage system by using I/O services.

The problem with the solutions offered in U.S. Pat. No. 5,906,658 by Raz is, as in the case of Whitney, legacy applications on mainframes must be rewritten in order to allow the plurality of processes to share data.

Therefore, there is a need to provide a system where rewriting or recording of applications is not needed for communication of mainframe computers in an open environment. Furthermore, there is a need to provide access to multiple requests for a mainframe simultaneously. Existing solutions only provide access to the data one requestor at a time. The other requests must wait in line until such access can be provided. Accordingly, it is desirable to provide a system that can provide access to legacy data without the need to rewrite applications.

### SUMMARY OF THE INVENTION

In a first aspect of the invention, an apparatus is provided that grants simultaneous access to data stored in a mainframe environment. The apparatus includes an emulation, which contains the data, that appears to a mainframe computing system as a peripheral device. The peripheral device allows access to the data to more than one requester simultaneously by creating a unique nominal ID for each request. The peripheral device in the preferred embodiment is a tape drive.

In another aspect of the invention, the emulation is a message queue server system. The server system includes a device emulator coupled to a first device having a first protocol, a digital storage coupled to the device emulator for temporary storage of information from the first protocol, at least one manager (i) coordinating the transfer of information of the first protocol between the device emulator and the digital storage and (ii) coordinating transfer of the information between the digital storage and a second protocol.

In another aspect of the invention, a request for access results in the generation of a device designation, a dataset name, the nominal ID and the retention period. The nominal ID is a unique code for each request.

Each request is given access to the latest version of the data.

Furthermore, each new version creates a new key for the data. All requests transparently use the latest request key at run time to gain access tothe most current version of the data.

In an alternate embodiment of the invention, a method for granting simultaneous access to data stored in a mainframe environment is provided. The steps to this method include emulating a peripheral device in a mainframe environment, storing the data on the peripheral device and generating a unique nominal ID for each mainframe request to access the data.

Additional steps to the method occur upon a request for data. The steps include designating a device, designating a dataset name, generating the nominal ID, designating the retention period for the data.

The alternate embodiment ensures that all requests to data have access to the data. Further, the step of generating access to the most current data is an important element of the invention. Therefore, each requestor is ensured of the most current version of the data. As new versions of a dataset are created, prior requests for access are matched with the dataset name of the newly-created version. When a match occurs, the prior request is updated to reflect the most current version of the data.

In another alternate embodiment, an apparatus for granting simultaneous access to data stored in a mainframe environment includes means for emulating a peripheral device in a mainframe environment, means for storing the data on the peripheral device and means for generating a unique nominal ID for each mainframe request to access the data.

In the preferred embodiment, the means for emulating utilizes a message queue server. The queue server allows open systems and mainframes to access the data without the need for recoding or rewriting of legacy applications.

An additional element to this apparatus is means for generating access to the most current data. Therefore, a requestor is ensured that when a request is made, they are indeed getting the most up to date information.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings.

The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of an environment in which mainframe computers are used with computer tapes to share data among the mainframe computers.

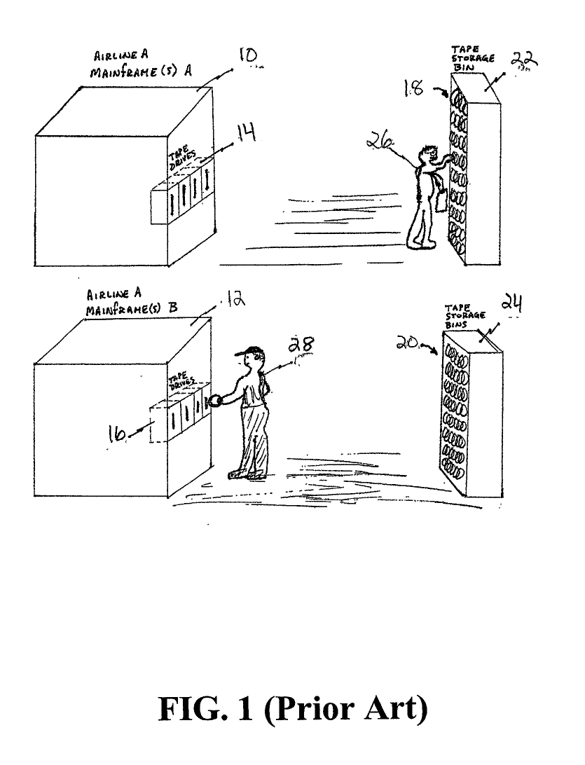

FIG. 2 is a block diagram of a prior art solution to sharing data between mainframes without having to physically transport tapes between the mainframes.

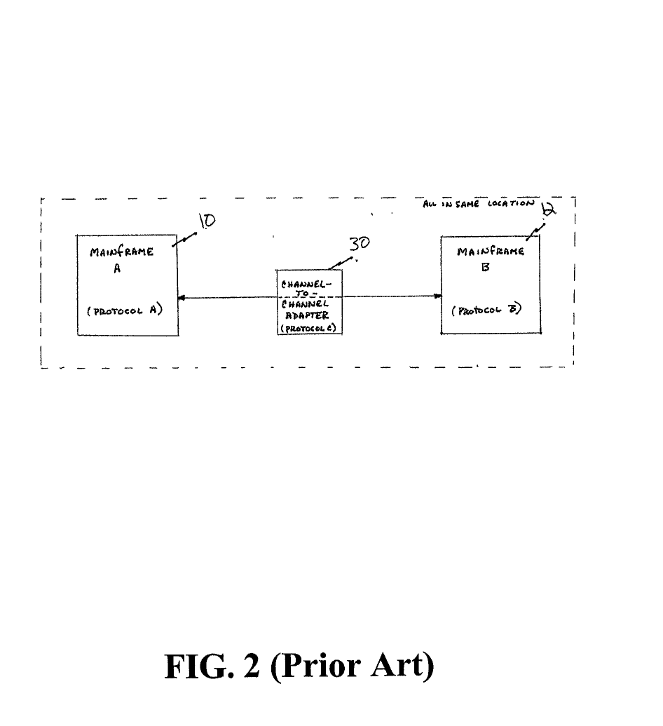

FIG. 3 is a block diagram in which a mainframe is able to share data with an open system computer network via a queue manager according to the principles of the present invention.

FIG. 4 is a block diagram of real and virtual tape devices in a mainframe environment.

FIG. 5 illustrates the configuration of two virtual devices configured on AutoMount mode.

FIG. 6 illustrates the creation of a new edition of a dataset name according to the principles of the present invention.

FIG. 7 illustrates a virtual tape configuration according to the principles of the present invention.

### DETAILED DESCRIPTION OF PREFERRED EMBODIMENTS OF THE INVENTION

A preferred embodiment of the present invention provides an apparatus and method for granting access to the same data simultaneously in a mainframe environment by emulating a peripheral device such as tape drive.

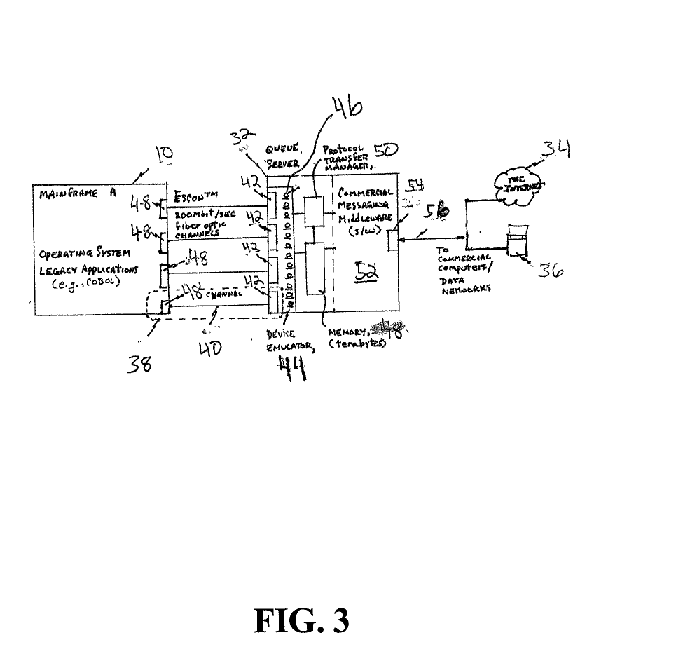

FIG.3 is a block diagram of a mainframe 10 (Mainframe A) in communication with a queue server 32. The queue server 32 is in communication with a computer network 34 (e.g. the Internet) and an open system computer 36.

Mainframe A 10 has an operating system and legacy applications such as applications written in COBOL. The operating system and legacy applications are not inherently capable of communicating with today's open system computer networks and computers. Mainframe A 10, however, does have data useful to an open system and other mainframes, so the queue server 32 acts as a transfer agent between Mainframe A 10 and computers connected to the open system computer networks and computers.

To transfer data between Mainframe A 10 and the queue server 32, Mainframe A 10 provides data to a channel 38. The channel 38 includes three components: a communication link 40 and two interface cards 42, one located at Mainframe A 10 and the other at the queue server 32. The interface card 42 20 located in the queue server 32 may support block message transfers and non-volatile memory. Mainframe A 10 also receives information from the queue server 32 over the same channel 38. The channel 38 is basically transparent to Mainframe A 10 and the queue server 32.

Mainframes, such as Mainframe A 10, have traditional device peripherals that support the mainframes. For example, mainframes are capable of communicating with printer and tape drives. That means that the applications running on the operating system on Mainframe A 10 have the hooks for communicating with a printer and tape drive. The queue server 32 takes advantage of this commonality among the mainframes by providing an interface to the legacy applications with which they are already familiar. Here, the queue server 32 has a device emulator 44 that serves as a transceiver with the legacy applications via channels 38. Thus, rather than reinventing the wheel by providing a MQF (message queue facility) that is a stand-alone device and requires legacy applications to be rewritten to communicate with them, the queue server 32 emulates a peripheral to mainframes.

The device emulator 44 is composed of multiple tape drive emulators 46. In actuality, the tape drive emulators 46 are merely software instances that interact with the interface cards 42. The tape drive emulators 46 provide low-level control reactions that adhere to the stringent timing requirements of traditional commercial tape drives that mainframes use to read and write data. In this way, the legacy applications are under the impression that they are simply reading and reading data from and to a tape drive, unaware that data is being transferred to computers using other protocols.

In practice, the data received by the tape drive emulators 46 are provided to memory 48, as supported by a protocol transfer manager 50. Once in memory 48, the data provided by the legacy applications are then capable of being transferred to commercial messaging middleware 52.

The commercial messaging middleware 52 interfaces with an interface card 54, such as a TCP/IP interface card that connects to a modem computer network, such as the Internet 34, via any type of network line 56. For example, the network line 56 could be a fiber optic cable, local area network cable, wireless interface, etc. Further, a desktop computer 36 could be directly coupled to the commercial messaging middleware 54 via the network line 56 and TCP/IP interface card 54.

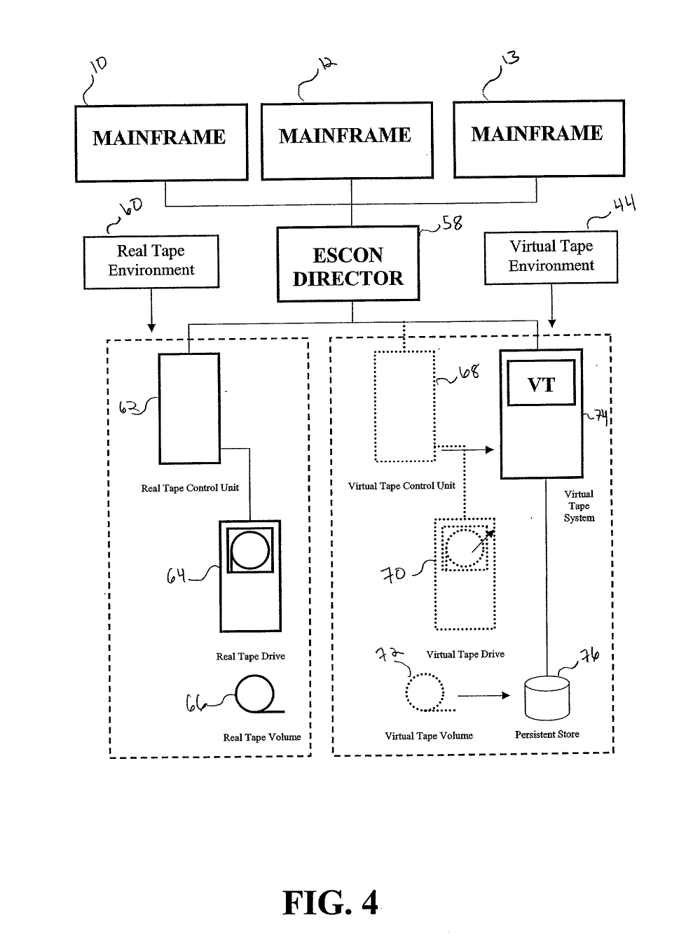

FIG. 4 is a block diagram of a real and virtual tape devices in a mainframe environment. In this figure, Mainframe A 10, Mainframe B 12 and Mainframe C 13 are connected through an ESCON director 58. The director 58, a dynamically modifiable switch, interconnects the mainframe computers 10,12,13 with each other and with attached storage using optical fiber technology.

In a real tape environment 60 with optical interconnection, the director 58 connects or links to the real tape unit 62. The environment further consists of a real tape drive 64 and a real tape volume 66. The real tape unit 62 contains data that is available to those computers (e.g., mainframes 10, 12, 13) that have access to the environment.

In the preferred embodiment, in order to provide simultaneous access to data stored on a mainframe, a virtual tape system is created. FIG. 4 depicts how a virtual tape environment appears to mainframes 10,12,13 in the environment. To the mainframes 10, 12, 13, the virtual tape environment 44 appears as a real tape environment consisting of a tape control unit 68, a tape drive 70 and a tape volume 72. In actuality, the virtual tape environment 44, the tape control unit 68 and the tape drive 70 combine to form a virtual tape system also known the queue server 32. The tape volume 72 is in actuality a persistent store 76 that contains the data in the tape volume 72. The virtual tape system appears to mainframes as one or more tape control units, which are defined in each mainframe's Input/Output Control Program.

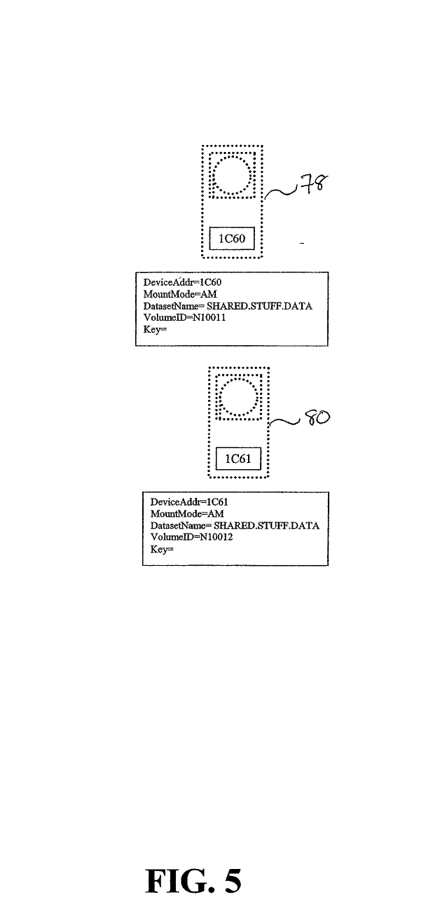

FIG. 5 illustrates the configuration of two virtual devices configured as AutoMount mode. A device is configured via a command expression known as AutoMount. All devices that are configured with the AutoMount designation are read-only.

In the preferred embodiment, the AutoMount permanently associates a virtual tape environment 44 with a single 17-character dataset name. For example in FIG. 5, the virtual tape system 78 is given the dataset name SHARED.STUFF.DATA. The invention enables more than one virtual tape system to be configured in AutoMount mode for the same dataset name. In FIG. 5, another virtual tape system 80 is configured with the same dataset name. All jobs using a given AutoMount device are presented with the latest edition of the dataset whose name is specified in the device's configuration record.

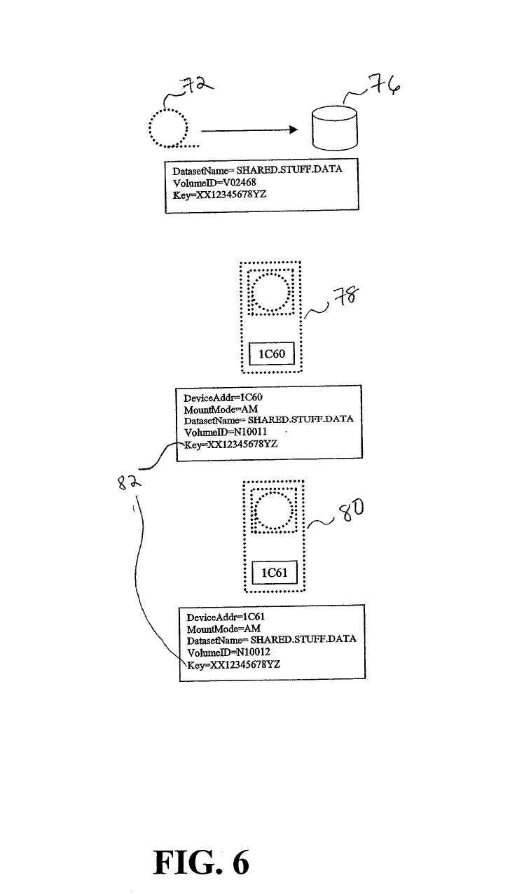

FIG. 6 illustrates the creation of a new edition of a dataset name according to the principles of the present invention. To illustrate the creations of the new edition, the following an excerpt from a set of Job Control Language (JCL) statements is provided:

//OUTPUT DD UNIT=/1AA4, DSN=SHARED.STUFF.DATA //LABEL=(,SL), RETPD=7

Continuing on the previous example, a write job on the mainframe is created with the dataset name SHARED.STUFF.DATA. The JCL above specifies the device to be used, the dataset name, the label type and the retention period.

After the job runs and the virtual tape volume 72 is written to the persistent store 76, the AutoMount devices, 78, 80 whose dataset name matches the name of the data just written, are updated to reflect a new key 82. The new key 82 references the underlying data in the persistent store.

The new key 82 is used to obtain the data presented to the users of this device until such time as another write job writes a new dataset for SHARED.STUFF.DATA or the configuration is changed. Therefore, requestors or accessors to the data are ensured on having the most current version of the software.

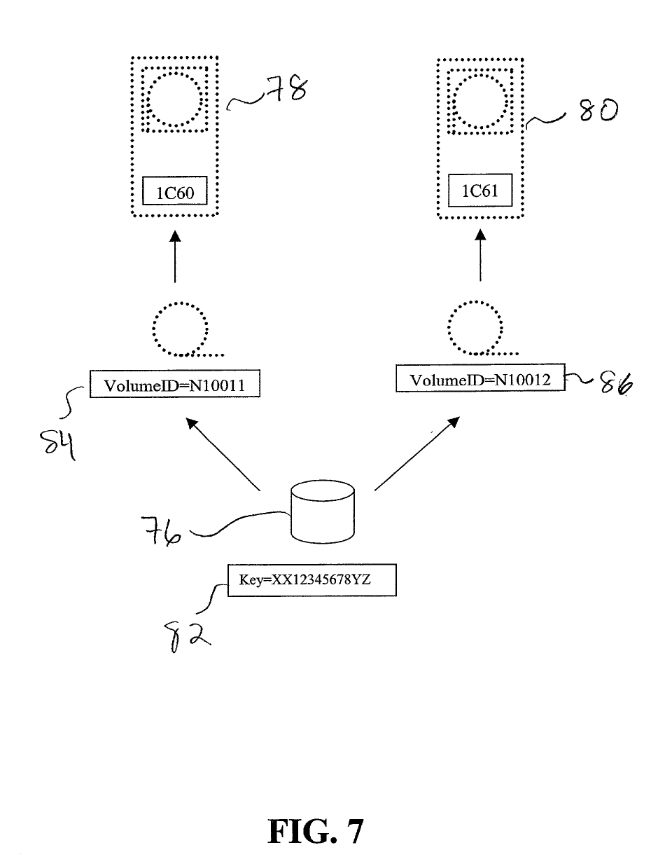

FIG. 7 illustrates a virtual tape configuration according to the principles of the present invention. In the preferred embodiment, a plurality of requesters for the same data stored on a mainframe are allowed access to the data.

In mainframe computing systems, access to a non-shareable volume of data on a peripheral device such as magnetic tape mounted is limited to one requester at a time. In practice, multiple users must wait their turn to access to the data.

The invention allows multiple access to the data by spoofing the mainframe into thinking that only one mainframe job is accessing the data. How, it accomplishes this task is by presenting each request with a unique nominal identification (ID). Therefore, the operating system believes that the virtual tape drive is being read by only one device at a time. However, in reality the nominal IDs are really presenting the same data to a multitude of requestors simultaneously.

The following JCL excerpts are from two read jobs and the resultant virtual tape configuration:

//INPUT DD UNIT=/1C60, DSN=N/10011.SHARED.STUFF.DATA, //VOL=SER=N10011

//INPUT DD UNIT=/1C61, DSN=N/10012.SHARED.STUFF.DATA, //VOL=SER=N10012

From two requests for the same data, the persistent store 76 activates the virtual tape systems 78, 80. In activating the dual system 78, 80, the same dataset name is used for each request but a different nominal ID 84, 86 is generated for each request. Once the dataset name and nominal IDs are generated, the data appears or is seen by the mainframe computers 10, 12, 13 as a peripheral device such as a tape drive. A mainframe then reads the data contained in the message queue or virtual tape system 78, 80 non-destructively in a serial fashion with a standard tape label. This overcomes the physical limitation of a real tape, which can only be mounted on a single tape at any given time.

Furthermore, as long as the rightmost seventeen characters of the dataset name are consistent among all jobs reading or writing the dataset, and the read job dataset names are unique to the left of the rightmost seventeen characters, these jobs execute simultaneously and coherently.

Each virtual tape system, 78, 80 are given the same key 82. The key is related to the data in the persistent store 76, which holds the data. Each time a new request for access is generated, the most current version of the data is added to the persistent store. For every instance of updating, a new key 82 is generated and passed along to all virtual tape systems 78, 80 that were generated from the data. In other words, the key 82 is a pointer to the virtual tape systems 78, 80 to an updated version of the data.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus that grants simultaneous access to data stored in a mainframe environment, comprising:
an emulation, which contains the data, appears to a mainframe computing system as a peripheral device wherein the peripheral device provides access to the data to a plurality of requesters simultaneously through the creation of a unique nominal identification (ID) for each request.

2. An apparatus as in claim 1, wherein the peripheral device is a tape drive.

3. An apparatus as in claim 1, wherein the emulation is a message queue server system.

4. An apparatus as in claim 3, wherein the message queue server system is comprised of a device emulator coupled to a first device having a first protocol, a digital storage coupled to the device emulator for temporary storage of information from the first protocol, at least one manager (i) coordinating the transfer of information of the first protocol between the device emulator and the digital storage and (ii) coordinating transfer of the information between the digital storage and a second protocol.

5. An apparatus as in claim 1, wherein a request for access results in device designation, a dataset name, the nominal ID and the retention period.

6. An apparatus as in claim 5, wherein the request for access is given the latest data stored in the memory.

7. An apparatus as in claim 6, wherein a prior request for the data whose dataset name matches the name of the data in the request for access is updated to reflect the most current version of the data.

8. A method for granting simultaneous access to data stored in a mainframe environment, the steps comprising:
emulating a peripheral device in a mainframe environment;
storing the data on the peripheral device; and
generating a unique nominal ID for each mainframe request to access the data.

9. The method as in claim 8, wherein the step of emulating utilizes a message queue server.

10. The method as in claim 8, wherein the peripheral device is a tape drive.

11. The method as in claim 8, where the reques t for access to t he data further comprises the steps of designating a device, designating a dataset name, generating the nominal ID, designating the retention period for the data.

12. The method as in claim 8, further comprising the step of generating access to the most current data.

13. The method as in claim 12, wherein access to the most current data for a prior request for access is accomplished through a match in the dataset name of a recent access for data and is updated based upon the recent access to reflect the most current version of the data.

14. An apparatus for granting simultaneous access to data stored in a mainframe environment, comprising:
means for emulating a peripheral device in a mainframe environment;
means for storing the data on the peripheral device; and
means for generating a unique nominal ID for each mainframe request to access the data.

15. The apparatus as in claim 14, wherein the means for emulating utilizes a message queue server.

16. The apparatus as in claim 14, wherein the peripheral device is a tape drive.

17. The apparatus as in claim 14, further comprising means for generating access to the most current data.

18. The apparatus as in claim 14, further comprising means for updating prior request for access with the most current version of the data.

19. The apparatus as in claim 14, wherein the means for updating is a key that references the data in a persistent store.

20. The apparatus as in claim 14 wherein the means for storing comprises at least one of the following storage devices: magnetic disk, optical disk and digital memory components.
